(19) United States
(12) Patent Application Publication
(10) Pub. No.: US 2015/0185999 A1
(43) Pub. Date: Jul. 2, 2015

(54) DISPLAY CONTROL APPARATUS AND CONTROL METHOD FOR VEHICLE

(71) Applicant: HYUNDAI MOTOR COMPANY, Seoul (KR)

(72) Inventors: Jong Yong NAM, Seongnam-si (KR); Ho Taek Lee, Seoul (KR); Tae Yub Kim, Jinju-si (KR); Yong Lee, Suwon-si (KR); In Seong Park, Seoul (KR)

(73) Assignee: HYUNDAI MOTOR COMPANY

(21) Appl. No.: 14/515,171

(22) Filed: Oct. 15, 2014

(30) Foreign Application Priority Data
Dec. 30, 2013 (KR) 10-2013-0167820

(51) Int. Cl. G06F 3/0484

(52) U.S. Cl. CPC G06F 3/0484

(57) ABSTRACT

A display control apparatus controls such that a graphical user interface is displayed on a screen of a display apparatus which is mounted to the vehicle. The apparatus includes a body information detector configured to detect body information for determining a body type of a driver. A position information detector is configured to detect position information for determining each position of each part of a body according to a sitting posture of the driver. A controller is configured to receive the body information and the position information detected from the body information detector and the position information detector to reposition the graphical user interface area such that the graphical user interface is displayed on the screen. The graphical user interface area is repositioned in an operating area where the driver can easily operate the screen.

### CROSS-REFERENCE TO RELATED APPLICATION

This application claims the benefit of priority to Korean Patent Application No. 10-201 3-01 67820 filed in the Korean Intellectual Property Office on Dec. 30, 2013, the entire contents of which are incorporated herein by reference.

### TECHNICAL FIELD

The present disclosure relates to a display control apparatus and a display control method for a vehicle. More particularly, the present disclosure relates to a display control apparatus and a display control method for a vehicle, which is easily operated by a driver.

### BACKGROUND

Generally, a display apparatus for a vehicle is used for visually transmitting various information, such as for navigation, driving condition, and a parking guide.

Recently, the screen area of the display apparatus provided for the vehicle has become wider to ensure visibility of a driver. However, it may not be convenient for the driver to directly touch the screen for handling.

In addition, handling a touch screen may be varied according to body type or sitting posture of the driver. Therefore, a means for handling the screen may be additionally installed at a position for any body type or sitting posture.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a display control apparatus and a display control method for a vehicle having advantages in which a driver can easily manipulate a screen without installing an additional handling means.

A display control apparatus according to an exemplary embodiment of the present disclosure, a graphical user interface is displayed through a screen of a display apparatus which is mounted to the vehicle. The apparatus may include a body information detector configured to detect body information for determining a body type of a driver. A position information detector is configured to detect position information for determining each position of each part of a body according to a sitting posture of the driver. A controller is configured to receive the body information and the position information detected from the body information detector and the position information detector to reposition a graphical user interface area such that the graphical user interface is displayed on the screen. The graphical user interface area may be repositioned in an operating area such that the driver can easily operate the screen.

The controller may predict the operating area according to the body information and the position information transmitted from the body information detector and the position information detector.

The graphical user interface area may be repositioned to be inside the operating area.

The graphical user interface area may be reduced to be inside the operating area.

A display control method for a vehicle according to an exemplary embodiment of the present disclosure controls such that a graphical user interface is displayed through a screen of a display apparatus which is mounted to the vehicle. The method may include detecting body information for determining a body type of a driver. Position information for determining each position of each part of a body is detected according to a sitting posture of the driver. A operating area where the driver can easily operate the screen on the screen is predicted based on the body information and the position information. Whether or not the graphical user interface area where the graphical user interface is represented on the screen is positioned in the operating area is determined. The graphical user interface area is repositioned to be inside the operating area on the screen if the graphical user interface area is not positioned in the operating area.

The body information and the position information may be detected again if the graphical user interface area is positioned in the operating area.

The body information may be simultaneously detected as the position information is detected.

The method may start when the display apparatus is turned on.

The method may end if the graphical user interface area is repositioned, and restart if another driver is seated.

The method may once end if the graphical user interface area is repositioned, and restart if the posture of the driver is changed.

### BRIEF DESCRIPTION OF THE DRAWINGS

FIG. 1 is a drawing which schematically shows an interior of a vehicle where a display apparatus according to an exemplary embodiment of the present disclosure is disposed.

FIG. 2 is a schematic diagram of a display apparatus according to another exemplary embodiment of the present disclosure.

FIG. 3 is a block diagram of a display control apparatus according to an exemplary embodiment of the present disclosure.

FIG. 4 is a flowchart of a display control method according to an exemplary embodiment of the present disclosure.

### DETAILED DESCRIPTION

An exemplary embodiment of the present disclosure will hereinafter be described in detail with reference to the accompanying drawings.

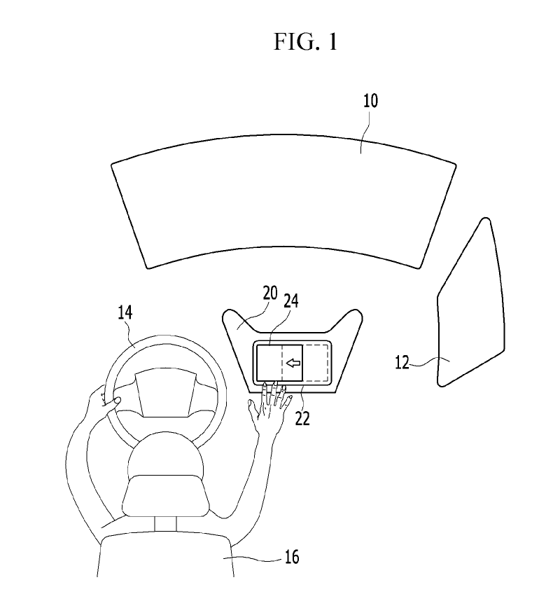

FIG. 1 is a drawing schematically showing an interior of a vehicle in which a display apparatus according to an exemplary embodiment of the present disclosure is disposed.

As shown in FIG. 1, a display apparatus 20 of a vehicle according to an exemplary embodiment of the present disclosure includes a screen 22. In addition, FIG. 1 schematically shows a position of the display apparatus 20. Further, a windshield 10, a door glass 12, a steering wheel 14, and a driver seat 16 are illustrated for visually showing the position of the display apparatus 20 in FIG. 1.

The screen 22 is a monitor displaying an image for a user. In addition, the screen 22 has a graphical user interface (GUI) area 24.

The GUI area 24 is an area where a GUI is represented on the screen 22. In addition, the driver or any user manipulates the screen 22 by touching the GUI area 24. That is, the GUI area 24 is a portion where buttons (not shown) and the like are displayed on the screen 22 when the screen 22 is a touch screen type. Herein, the screen 22 and the GUI are well-known to a person of ordinary skill in the art, so a detailed description thereof will be omitted.

The display apparatus 20 is mounted to an instrument panel at the rear of the windshield 10 and is disposed adjacent to the steering wheel 14, such that the driver on the driver seat 16 recognizes contents represented on the screen 22. The steering wheel 14 protrudes more than the display apparatus 20 from the instrument panel.

Generally, the driver operates the steering wheel 14 and the screen 22 when sitting in the driver seat 16. The steering wheel 14 and the driver seat 16 can be adjusted by considering a body type and a sitting posture of the driver. The GUI area 24 may display at a position on the screen 22 where the driver cannot easily operate if the steering wheel 14 and the driver seat 16 are set regardless of the body type and sitting posture of the driver.

In an exemplary embodiment of the present disclosure, the GUI area 24 is repositioned to where the driver can easily operate in a case that the GUI area 24 displays at the position where the driver cannot easily operate it. FIG. 1 illustrates that the graphical user interface area 24 is moved from an area represented by a dotted line to an area represented by a solid line along an arrow direction on the screen 22, however, it is not limited thereto. For example, the GUI area 24 may become the entire screen 22, or may become smaller such that the screen 22 can be easily operated by the driver.

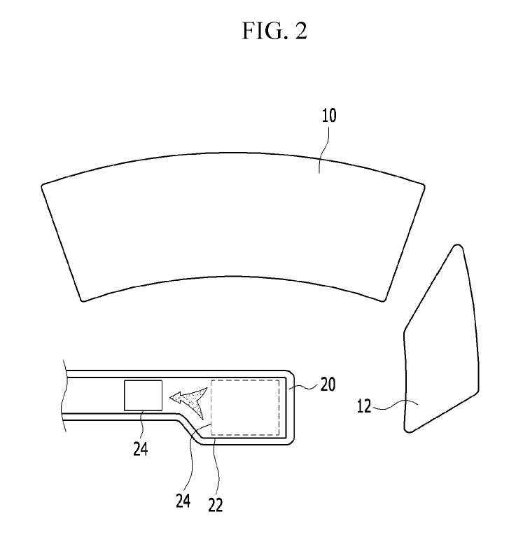

FIG. 2 is a schematic diagram of a display apparatus according to another exemplary embodiment of the present disclosure.

FIG. 2 shows the case that the screen 22 is extended toward an instrument cluster on the instrument panel. That is, a length and a range of the screen 22 are expanded such that the display apparatus 20 is extended from a center portion of the instrument panel toward a front side of a driver. In this case, a range of motion in which the GUI area 24 moves to be easily operated by the driver may be expanded, thus, improving the operability for the driver.

The GUI area 24 may be enlarged to become the entire screen 22, or be reduced so as to be positioned at a center portion of the instrument panel. In addition, the GUI area 24 freely and selectively moves in from the center portion of the instrument panel to the front side of the driver so as to avoid a reflection area L. Further, the GUI area 24 can be reduced in considering an interference with other display objects by a person of ordinary skill in the art in case that the GUI area 24 moves to the instrument cluster disposed at the front side of the driver. In FIG. 2, the GUI area 24 is moved to where the instrument cluster is disposed as represented by an arrow.

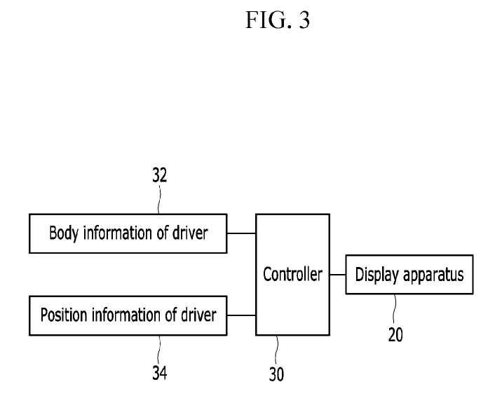

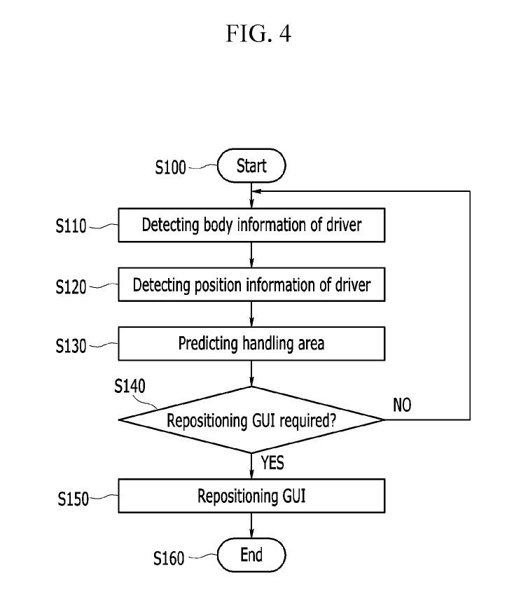

Referring to FIGS. 3 and 4, display control in which the GUI area 24 is adjusted so as to be easily operated by a driver on the screen 22 will be described in detail.

FIG. 3 is a block diagram of a display control apparatus according to an exemplary embodiment of the present disclosure.

As shown in FIG. 3, a display control apparatus according to an exemplary embodiment of the present disclosure includes a controller 30, a body information detector 32, and a position information detector 34.

The controller 30 receives body information and position information of a driver to control the display apparatus 20. That is, the controller 30 predicts an area on the screen 22 for the driver to easily operate according to the body information and the position information of the driver, and moves or reduces the GUI area 24 on the screen 22.

The body information detector 32 detects the body information of the driver and transmits the detected body information to the controller 30. Herein, the body information of the driver includes a driver's arm length, height when seated, and so on. In addition, the body information detector 32 means any apparatuses which may be mounted to surround the driver seat 16 so as to determine a body type of the driver. The apparatuses for determining the body type of the driver may include various sensors and cameras, and apparatuses and methods for determining the body type of the driver are well-known to a person of ordinary skill in the art.

The position information detector 34 detects the position information of the driver, and transmits the detected position information to the controller 30. Herein, the position information of the driver includes positions of shoulder lines and eye levels of the driver in the state of sitting on the driver seat 16. In addition, the position information detector 34 means any apparatuses which may be mounted to surround the driver seat 16 so as to determine the position of the driver. The apparatuses for determining the position of the driver may include various sensors and cameras, and the apparatuses and methods for determining the position of the driver are well-known to a person of ordinary skill in the art.

Detecting the body information and the position information can be performed without additional constituent elements and technical elements in a vehicle which applies the steering wheel 14 or the driver seat 16 designed to move according to the body type and sitting posture of a driver. Therefore, additional cost for detecting the body information and the position information may not be required.

FIG. 4 is a flowchart of a display control method according to an exemplary embodiment of the present disclosure.

As shown in FIG. 4, after the controlling display apparatus 20 according to an exemplary embodiment of the present disclosure starts (S100), the body information detector 32 detects the body information of the driver (S110). Herein, the control of the display apparatus 20 may simultaneously start when the display apparatus 20 is turned on.

The position information detector 34 detects the position information of the driver (S120) if the body information is detected. The body information in step S110 and the position information in step S120 may be simultaneously detected.

The controller 30 predicts an operating area on the screen 22 (S130) if the detected body information and position information are transmitted from the body information detector 32 and the position information detector 34, respectively, to the controller 30. The operating area is an area on which the driver can easily operate by considering driver's arm length, height when seated, a position of a shoulder line, and eye levels.

The controller 30 determines whether it is necessary to reposition the GUI area 24 on the screen 22 at step S140 by predicting the operating area. That is, the controller 30 determines whether the GUI area 24 is positioned in the operating area.

If it is determined that the repositioning of the GUI area 24 is not necessary, the above-mentioned steps are repeated from detecting the body information at step S110 and detecting the position information at step S120.

If it is determined that repositioning the GUI area 24 is required, the controller 30 repositions the GUI area 24 on the screen 22 at step S150. Herein, the repositioning of the GUI area 24 is the above-mentioned positioning and reduction of the GUI area 24.

If the GUI area 24 is repositioned, control of the display apparatus 20 ends at step S160.

At this time, the time of restarting control of the display apparatus 20 at step S100 may be a time when the driver or a driver's posture is varied. Determining the time that the driver or the driver's posture is varied may be variously realized by design of a person of ordinary skill in the art.

According to an exemplary embodiment of the present disclosure, the GUI area 24 is repositioned to be easily operated by a driver such that a driver can operate the screen 22 without an additional handling apparatus. In addition, the manufacturing cost is decreased because the additional handling apparatus is not required. Further, the GUI area 24 is repositioned according to the body type or the sitting posture of the driver such that the satisfaction of many drivers can be improved.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A display control apparatus for a vehicle, in which a graphical user interface is displayed on a screen of a display apparatus which is mounted to the vehicle, the display control apparatus comprising:
a body information detector configured to detect body information for determining a body type of a driver;
a position information detector configured to detect position information for determining each position of each part of a body according to a sitting posture of the driver; and
a controller configured to receive the body information and the position information detected from the body information detector and the position information detector to reposition a graphical user interface area such that graphical user interface is displayed on the screen,
wherein the graphical user interface area is repositioned in an operating area such that the driver can easily operate the screen.

2. The apparatus of claim 1, wherein the controller is configured to predict the operating area according to the body information and the position information transmitted from the body information detector and the position information detector.

3. The apparatus of claim 1, wherein the graphical user interface area is repositioned to be inside the operating area.

4. The apparatus of claim 1, wherein the graphical user interface area is reduced to be inside the operating area.

5. The apparatus of claim 1, wherein the graphical user interface area is enlarged to become the entire screen.

6. A display control method for a vehicle, in which a graphical user interface is displayed on a screen of a display apparatus which is mounted to the vehicle, the method comprising steps of:
detecting body information for determining a body type of a driver;
detecting position information for determining each position of each part of a body according to a sitting posture of the driver;
predicting an operating area where the driver can easily operate the screen based on the body information and the position information;
determining whether a graphical user interface area where the graphical user interface is displayed on the screen is positioned in the operating area; and
repositioning the graphical user interface area to be inside the operating area on the screen if the graphical user interface area is not positioned in the handling area.

7. The method of claim 6, wherein the steps of detecting the body information and the position information are performed again if the graphical user interface area is positioned in the handling area.

8. The method of claim 6, wherein the step of detecting the body information is simultaneously performed while the step of detecting the position information is performed.

9. The method of claim 6, wherein the method starts when the display apparatus is turned on.

10. The method of claim 6, wherein the method ends if the graphical user interface area is repositioned and restarts if another driver is seated.

11. The method of claim 6, wherein the method ends if the graphical user interface area is repositioned, and restarts if the sitting posture of the driver is changed.
